(19) United States
(12) Patent Application Publication
(10) Pub. No.: US 2008/0080456 A1
(43) Pub. Date: Apr. 3, 2008

(54) Method and Apparatus for Wireless Coordination of Tasks and Active Narrative Characterizations

(76) Inventor: Jeffrey B. Williams, El Cerrito, CA (US)

Correspondence Address: John Carpenter, Two Embarcadero Center, Suite 2000, San Francisco, CA, 94111, US

(21) Appl. No.: 11/537,498

(22) Filed: Sep. 29, 2006

(51) Int. Cl. H04B 7/216

(52) U.S. Cl. 370/342

(57) ABSTRACT

A self configuring network is set up between various actors that perform individual parts of a larger task. The larger task is, for example, a narrative and the individual parts are each a portion of the narrative. Each actor is, for example, an animated character, an audio device, and/or lighting display. The actors perform individual parts assigned by a controller and on cue according to a local heartbeat. A master heartbeat is maintained at the controller and each of the actors synch update local heartbeats to the master. The self configuring network includes an option to keep the network local, such that only actors in a certain household or neighborhood participate. Alternatively, the self configuring network may coordinate any available actors within range (e.g., wireless network) or otherwise capable of communicating with the controller or other devices in the network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to wireless communications. The present invention is more particularly related to the coordination and self-assembly of wireless network services. The present invention is still more particularly related to performing an extemporaneous narrative characterization using a collection of available actor devices that can render the narrative in a pleasing and entertaining manner. The invention is still more particularly related to managing network efficiency and reliability in the severely resource-constrained environments typical to battery-powered applications.

2. Discussion of Background

This specification presumes familiarity with the general concepts, protocols and devices commonly used in wireless networking, sound reproduction and motor control. A brief overview is provided.

General Wireless

Wireless personal area networks (PANs) are arrangements of various hardware and software elements that operate together to allow a number of digital devices to exchange data within the PAN, and also may include connections to external networks such as the Internet. FIG. 1 is a diagram representing a typical node in a PAN. Controller 110 contains a program that coordinates the activity of the node such as sending or receiving instructions/data over radio interface 100 or wired interface 120, collecting sensor data from the I/O controller, sending data to the I/O controller, and servicing any instructions or actions contained therein.

Topology

The topologies of these networks can be point-to-point (P2P), a star or a mesh. FIG. 2 is a diagram representing a PAN with a P2P topology. In the P2P topology each device is within radio range of every other device and each plays an equal role in control of the over-the-air (OTA) network. The peers usually choose a predefined channel where they can all find each other. The order of startup of the devices is not material to the formation of the network since each peer receives all packets sent by the other peers. FIG. 3 is a diagram representing a star topology. In the star topology one device acts as the controller 300 of the network. All devices must be within radio range of the controller. The end devices 310, 320, 330, 340 cannot form a network by themselves—they must wait for an active network controller. When the network controller starts it chooses the best channel for the new network, and also chooses a network ID. The controller then coordinates the formation of the network by advertising the new network, and allowing one or more end-devices to join it. The end devices each have a global unique identifier (GUID) the controller uses to coordinate the transmission of data. The controller may use the GUID to allow/disallow the device to join the network. For efficiency the controller may also assign a shorthand network address to each end device and then maintain a table of GUID-to-shorthand address pairs. The controller receives all transmissions from the end devices and re-transmits to the end devices if necessary. Normally the end devices do not communicate directly with each other except when it is possible to optimize use of the radio channel without disrupting the coordinator's control of the network. FIG. 4 is a diagram representing a mesh topology. The mesh topology works the same as the star, however a mesh removes the requirement that all end devices be within radio range of the controller. To accomplish this the mesh introduces the concept of a router. The router extends the authority of the controller to further distances to encompass end devices that are not within radio range of that controller. The router allows end devices to join the network formed by the controller as long as the router is within range of a controller or a series of routers where at least one of those routers is within radio range of the controller. The router also forwards transmissions to/from the end devices outside the radio range of the controller.

Packets

In a PAN data is generally transmitted between devices as independent packets, with each packet containing a header having at least a destination address specifying an ultimate destination and generally also having a source address and other transmission information such as transmission priority. Packets are generally formatted according to a particular protocol and contain protocol identifier of that protocol. FIG. 5 is a high-level diagram of a network packet 500. Each packet contains a header 560 that contains an Type/ID 510 that describes what the packet contains, its origin 520, and its destination 530, optional parametric information 540, and the actual payload 550.

Layers

Modern communication standard, such as the 802.15.4 standard, organize the tasks necessary for data communication into layers. At different layers, data is viewed and organized differently, different protocols are followed, different packets are defined and different physical devices and software modules handle the data traffic. FIG. 6 illustrates various examples of layered wireless network standards having a number of layers. Corresponding levels of the various network standards are shown adjacent to each other and the OSI layers, which are referred to herein as: the Physical later, the Data Link Layer, the Routing Layer. Like all modern networking, PANs support multiple protocol layers. The payload of a packet could contain another packet. FIG. 7 is a diagram of packet nesting that follows the organization of protocol layers. The lowest layer of the protocol stack corresponds to the outer-most packet 600. The highest protocol layer corresponds to the innermost packet 630.

Streams

Typical high-level network protocol layers provide a streaming mechanism whereby a continuous stream of bits is broken down into individual packets and transmitted over the network as packets. These high-level protocols contain extra packet information that allows the receiver to reconstitute the bit stream on the remote end. Since physical links are inherently unreliable the higher-level protocol can also provide a mechanism to guarantee the arrival of all of the original data in correct order. There are numerous strategies and standards that describe mechanisms for guaranteed delivery while maintaining minimal congestion. Usually this happens in the form of acknowledgements and retries. The receiver acknowledges each packet received. If the sender sends a packet and fails to get an acknowledgement within an expect time it can elect to resend the packet. The sender can also employ a congestion window that limits the number of sent, but unacknowledged packets to an optimal count.

Pulse Code Modulation

Pulse code modulation (PCM) is a form of analog data encoding that samples the magnitude of an analog signal at regular intervals. Each sample is represented by a fixed number of bits. FIG. 8 is a diagram of a PCM encoded sine wave. Each successive sample can be concatenated to the end of the previous sample to form a bit stream suitable for storage or transmission. The number of samples per second multiplied by the number of bits per sample yields the bit-rate of the encoded analog signal.

Pulse Width Modulation

Pulse width modulation is a form signal generation where a fixed-length pulse-train square wave signal is alternated between “high” and “low.” FIG. 9 is a diagram of a PWM signal. While the length of every pulse is a fixed time, the percentage of time “high” versus “low” varies. This variance is known as “duty cycle.” Each individual pulse always starts high and ends low with one transition, or always starts low and ends high with one transition. PWM signals have many uses in data communications, motor control, voltage regulation, and audio effects processing.

PWM Audio Effects Processing

By alternating the duty cycle (percent of time high vs. low) it is possible to recreate an analog audio signal. The average voltage of a PWM signal is equal to the ratio of high vs. low (duty cycle) multiplied by the absolute voltage of the high value. For example, a 3 V high signal and 50% duty cycle will yield an average voltage of 1.5 V. By varying the duty cycle according to a PCM encoded audio signal it is possible to recreate the original signal. Through the use of filtering and amplification it is possible to remove oscillations introduced by the PWM pulse rate.

PWM Motor Control

There are many ways to control motors with PWM. Two very common techniques are servo control and direct-drive DC motor control. Servo motors expect a PWM signal whose pulse period is 20 ms. By varying the duty cycle from 1 ms to 5 ms the servo will rotate between 0 deg and 180 deg respectively. An MCU can easily generate such a signal, so it is common for these kinds of devices to control servo-based motor systems. For full-rotation DC motors the use of PWM to vary the average voltage allows the MCU to control the speed of the motor. Since an MCU cannot generate large amounts of power it is common to amplify these signals using a motor controller known as an H-Bridge. The H-Bridge provides other features as well such as motor braking, direction changing and motor freewheeling.

PWM LED Control

A standard, non-blinking LED produces a constant illumination within its operating limits of voltage and power. It is possible to create the illusion of dimming and brightening an LED by using a PWM to vary the amount of time the LED is off or on. The percentage of the duty cycle is approximately the percentage of standard brightness of the LED. An MCU can easily produce such a signal, so it is common for these kinds of devices to control LEDs.

Audio Compression

Standard PCM-encoded audio signals contain about 50% redundant information. Using lossless compression techniques it is possible to remove this redundant information without losing any of the original audio signal. Using techniques of psychoacoustics it is possible to remove further information from the PCM-encoded stream, and as such losing some of the original audio signal, without introducing undesirable artifacts. In either case the rate of compression varies depending on the content of the original audio signal. Almost all of the popular audio compression techniques yield variable bit rate in the compressed signal compared to the fixed bit rate in the original PCM encoded signal.

Regular Expression

A regular expression is a pattern string that describes a set of strings based on regular expression syntax. The pattern string contains a set of atoms that include characters in the search space and special “command” characters outside of the search space. Standard expression syntax supports three important concepts: grouping, quantification and alternation. Grouping breaks up the pattern string into sub-strings that can act as a single atom in the search. Quantification indicates how many times a previous atom should appear in a string in order to qualify as a match. Alternation allows the pattern string to specify more than one choice for matching an atom. We use regular expression syntax similar to PERL or Unix “grep”.

### SUMMARY OF THE INVENTION

The present inventor has realized the need for efficient self assembling wireless networks, particularly but not limited to entertainment applications using animated characters. The present invention provides a self-assembling wireless network that can provide an extemporaneous entertainment such as a concert, narrative, theatrical, or interactive toy experience with little or no intervention on the part of the user. The invention also provides numerous, novel mechanisms needed to maintain synchronization (e.g.) a synchronized concert experience, due to a number of factors such as physical differences in the devices, slight differences in network reliability and reception, the variable nature of the event being synchronized (e.g.), content and external factors such as interfering radios.

In one embodiment, the present invention is a system that wirelessly choreographs various narrative characterizations among one or more end-device actors that can render those characterizations in a meaningful and entertaining way. Referring to the hierarchical structure of FIG. 21A, a narrative 2100 is a coordinated sequence 2104-2109 of actions 2110-2127 organized around a theme, and divided into one or more parts 2101-2103 for one or more actors 2136-2139. An actor is, for example, a narrative fictional character, non-fictional character, or an inanimate object with capability 2140-2147 of playing one or more parts 2101-2103. A part is, for example, a sequence 2104-2109 of actions 2110-2127. An action 2110-2127 is, for example, a request for physical performance including, but not limited to, dialogue, audio, light, animatronics, action, gesture, etc. A capability 2149-2147 is, for example, a physical control function within an actor 2136-2139 including, but not limited to, audio signal generation, motor control, light control, switch control, etc. Each capability 2149-2147 within an actor 2136-2139 is mapped to an addressable endpoint 2128-2135. A command 2110-2127 is a request for action 2110-2127 addressed to one or more endpoints 2128-2135 in one or more actors 2136-2139.

FIG. 21B is an example narrative mapping according to an embodiment of the present invention. In this example, a narrative 2150 leads to parts, sequences, and ultimately commands sent to various end device components (e.g., audio or servo mechanisms of an end device).

In one embodiment, peer-device actors broadcast queries in search of other peer-device actors with complimentary narrative characteristics. Peer-device actors within radio range will respond to the query. The broadcasting peer-device then decides which parts of the narrative to assign to which endpoints on which remote peers. The local peer-device accesses the narrative from a file, network, memory, or other digital source, and converts it into one or more multiplexed, multipart data/command packet streams, or one or more uni-part data/command packet streams suitable for transmission on the wireless network. Each peer-device actor receives the commands for its “part” from the other peer via the wireless network, and maps those commands to the appropriate I/O ports to render the action using light, sound, animatronics, or any other means of performance. This embodiment of the invention is largely, but not exclusively, oriented to real-time user interaction such as, but not limited to, switches, buttons, joysticks, microphones, sensors, etc.

In one embodiment a self-assembling wireless star network begins with a coordinator that establishes a network and later includes one or more end-devices actors within its radio range and control. The controller takes inventory of end-device actors on the network. Each end-device actor informs the controller of its narrative characteristics such as character name, gender, age, magical powers, team, etc. The end-device actor also informs the controller about what physical characteristics it supports including, but not limited to, audio, light, motor control, animatronics, etc. Using this inventory, the controller decides which parts of the narrative to assign to which endpoints on which end-device actors. The controller accesses the narrative from a file, network, memory, or other digital source, and converts it into one or more multiplexed, multipart data/command packet streams, or one or more uni-part data/command packet streams suitable for transmission on the wireless network. Each end-device actor receives the packet stream of commands for its “part” from the controller via the wireless network, and maps those commands to the appropriate I/O ports to render the action using light, sound, animatronics, or any other means of performance. Moreover, the controller synchronizes these actions to a master heartbeat to assure that each actor renders its actions in concert with all of the other actors. This embodiment of the invention is largely, but not exclusively, oriented to broadcast-style performances.

In one embodiment, the invention includes a broadcast form where the controller employs a synchronization scheme that sequences the actions on each endpoint. The controller maintains a master synchronization heartbeat in the form of a counter incremented at a precise, known rate. Commands sent by the controller contain an implicit or explicit synchronization number that indicates a relative or absolute heartbeat counter number for actions in the commands. The end-device actors maintain a remote heartbeat synchronous with the master heartbeat in controller. As the end-device actor receives a command it waits until the synchronization number matches the heartbeat number before it executes the action in that command. Due to physical differences in the devices, there may be some drift between the master heartbeat in the controller and the remote heartbeats in the end-device actors. Periodically, the controller will broadcast the current master heartbeat number. If an end-device actor discovers that it is ahead or behind the master heartbeat it can either slow or speed its remote heartbeat, and in turn slow or speed the rendering of the actions until it is back in synch. If the drift is just a few milliseconds the slight change in performance will not be perceptible to the user. In cases of extreme mismatch, such as a restart of the actor, the end-device actor will simply jump to the absolute master heartbeat, and will discard any actions now scheduled in the past.

The broadcast form of the invention also embodies rate matching between the controller and the end-device actors. Due to the synchronization described above, the controller knows with some certainty how much command data is pending in an endpoint's buffer waiting for execution. To make better use of the radio channel, the controller sends commands to endpoints at most convenient time prior to the scheduled execution time of the command. To facilitate this process, part of the endpoint descriptor informs the controller of how much data it can buffer. During each packet transmission cycle the controller decides, at its convenience, which endpoints are best in need of command data during the current transmission cycle. The controller does this without the need for acknowledgement or status transmission from the end-device actors. This avoids the problem of significant dead-air waiting for end-device actor responses. In other embodiments, a device or system could elect to use ACKs, either exclusively or when a current state of network traffic makes their use efficient (e.g., when network resources are not scarce).

Thus, present invention includes a system that does not tie-up the airwaves waiting for acknowledgements. There is a trade-off between absolute maximum time broadcasting vs. absolute accuracy. In this aspect of the invention, efficiency trumps accuracy, and the heartbeat mechanism serves to “smooth out” gaps caused by missing packets.

In the non-broadcast embodiment of the invention, the controller sends multiple “sequences of commands”, each identified by an identifier. At run-time, it provides the actual identifier to be executed.

At least portions of the device, system, and method may be conveniently implemented on a wireless electronic developer kit (EDK), and the results may be experienced using a speaker, motor, and/or LED. In various embodiments, the invention or portions of the invention may be embodied as instructions, commands, or date encoded in an electronic signal and transmitted on wire or wirelessly between devices.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a controller and related equipment in a self configuring wireless network according to an embodiment of the present invention;

FIG. 2 is drawings illustrating peer relationships according to an embodiment of the present invention;

FIG. 3 is a drawing of controller to device relationships according to an embodiment of the present invention;

FIG. 4 is a drawing of router expanded controller to device relationships according to an embodiment of the present invention;

FIG. 5 is a packet diagram;

FIG. 6 is an illustration of packetization in a multilayered transmission protocol;

FIG. 7 is a comparison of various transmission protocols;

FIG. 8 is a graph of pulse code modulated (PCM) signal;

FIG. 9 is a comparison of a source signal and corresponding source signals;

FIG. 10A is an example of parts for a themed narrative according to an embodiment of the present invention;

FIG. 10B is an illustration of an example part descriptor according to an embodiment of the present invention;

FIG. 10C is an illustration of an example 1^{st} portion of a sequence descriptor according to an embodiment of the present invention;

FIG. 10D is an illustration of an example 2^{nd} portion of a sequence descriptor according to an embodiment of the present invention;

FIG. 11 is a mapping of endpoints to I/O ports within the remote device actor;

FIG. 12 is an illustration of action and endpoint descriptors for a set of actors according to an embodiment of the present invention;

FIG. 13 is an example of an allocation of narrative parts to actors according to an embodiment of the present invention;

FIG. 14 is a schematic of an implementation of a controller according to an embodiment of the present invention;

FIG. 15 is a schematic of an implementation of an End-Device Actor according to an embodiment of the present invention;

FIG. 16A is an example of a narrative data structure according to an embodiment of the present invention;

FIG. 16B is an example of a part descriptor according to an embodiment of the present invention;

FIG. 16C is an example of a sequence descriptor according to an embodiment of the present invention;

FIG. 17 is an illustration of an example synchronization flow according to an embodiment of the present invention;

FIG. 18A is an illustration of a Late synchronization according to an embodiment of the present invention;

FIG. 18B is an illustration of an early synchronization according to an embodiment of the present invention;

FIG. 19 is an example command structure according to an embodiment of the present invention;

FIG. 20 is an illustrative overview of an embodiment of the present invention;

FIG. 21A is an example of a narrative structure according to an embodiment of the present invention;

FIG. 21B is an example narrative mapping according to an embodiment of the present invention;

FIG. 22 is a Universal Modeling Language (UML) sequence diagram of a process for locating and matching End-Device Actors to Parts according to an embodiment of the present invention;

FIG. 23 is a UML sequence diagram of a process for starting a self-configuring network according to an embodiment of the present invention;

FIG. 24 is a flow chart illustrating logic of a narrative controller according to an embodiment of the present invention;

FIG. 25 is a flow chart illustrating a process/logic for matching Endpoints to the Sequences according to an embodiment of the present invention.

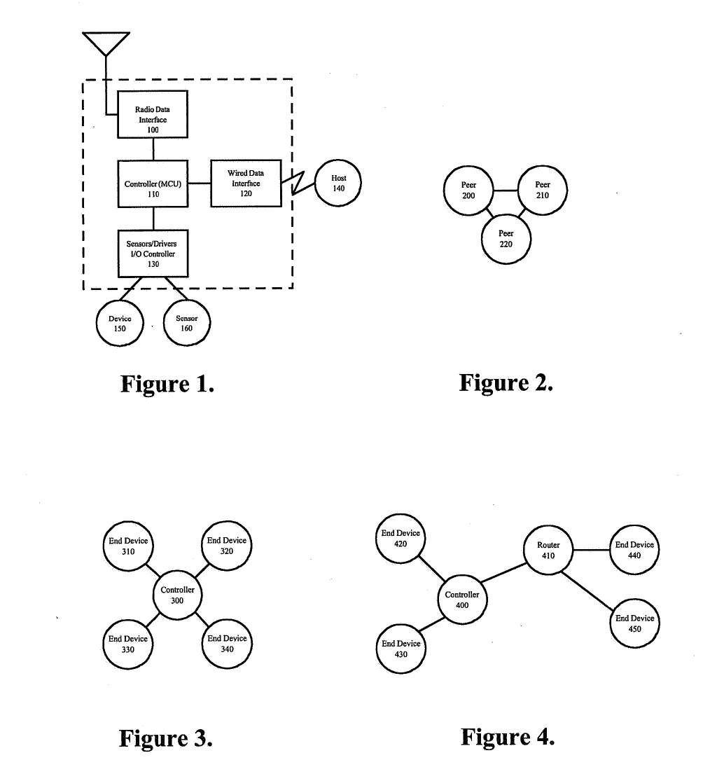

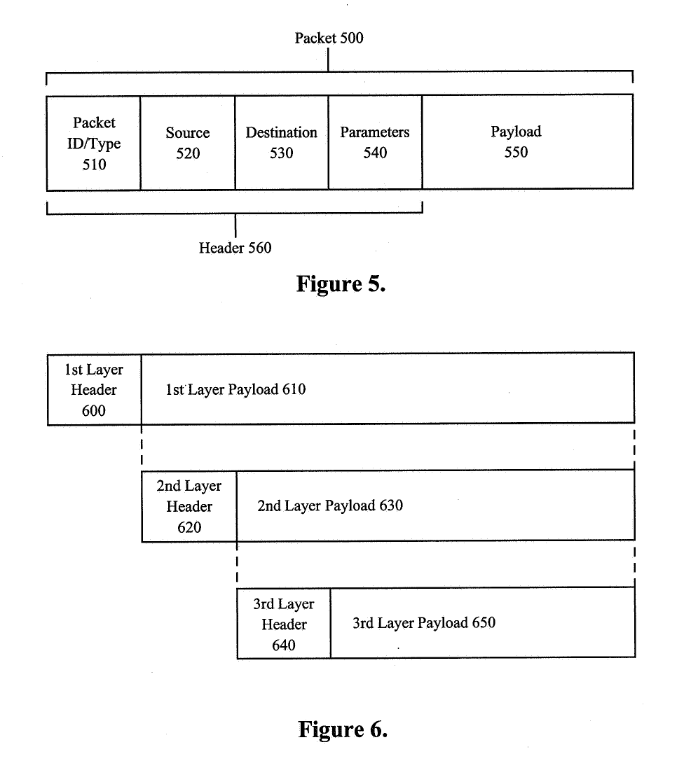

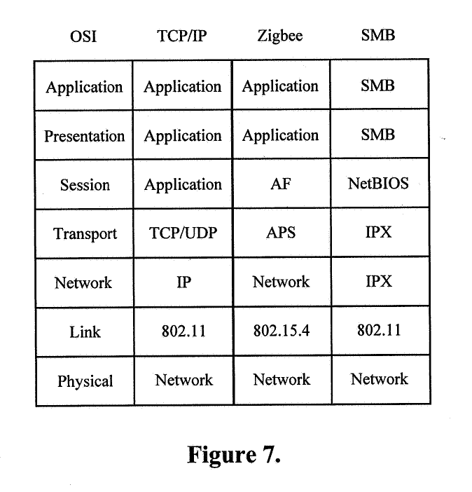

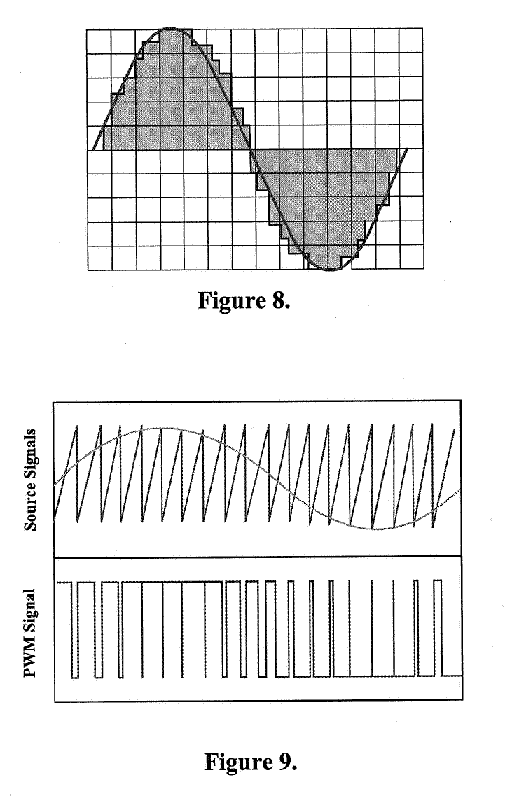

### DESCRIPTION OF THE PREFERRED EMBODIMENTS

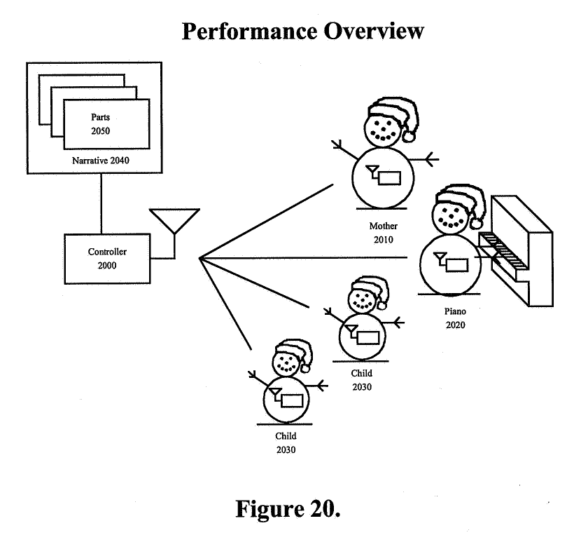

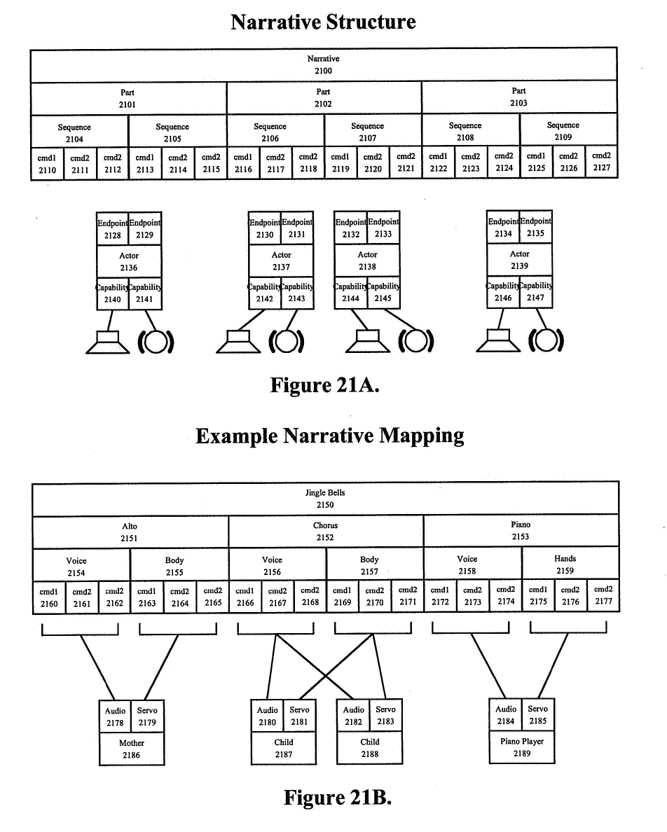

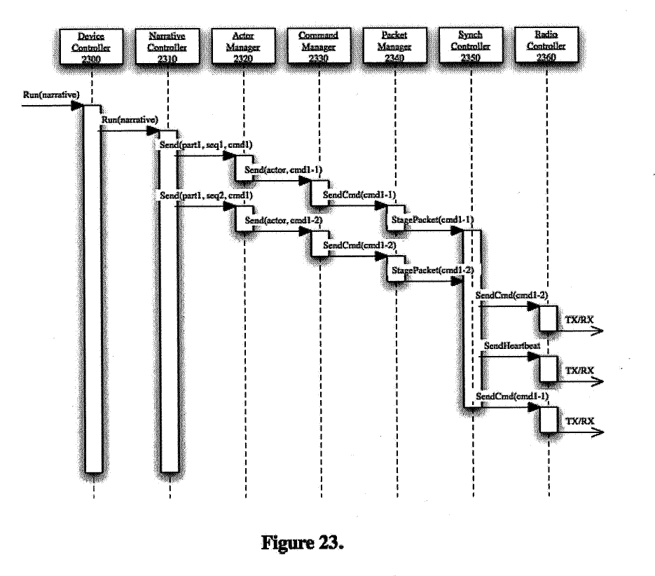

Referring again to the drawings, wherein like reference numerals designate identical or corresponding parts, and more particularly to FIG. 20 thereof, there is illustrated a block diagram of a multi-actor performance network according to the present invention. FIG. 23 contains a Universal Modeling Language (UML) sequence diagram for the process of starting the network of depicted in FIG. 20. Referring to FIG. 20, data for the Narrative 2040 is accessed from storage or a network, and transported to the controller 2000. The Controller 2000 takes inventory of all Parts 2050 in the Narrative 2040. The Controller searches for End-Device Actors that are within radio range or are reachable over a routed, mixed wired and wireless network.

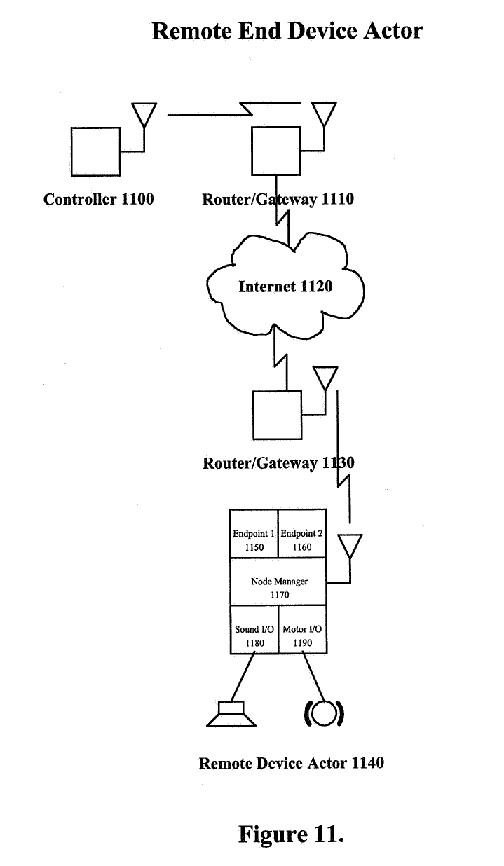

FIG. 11 contains a diagram of an embodiment of the application that uses the Internet to reach at least one of the End Device Actors. The Controller 1110 discovers and communicates with End Device Actor 1140 via the wireless/wired router/gateway 1110 across the Internet 1120 to another wired/wireless router/gateway 1130 at the remote location. In this way the user may interact with a larger narrative managed from a central location across a large geographic region encompassing many End Device Actors working in concert. Narratives from, but not limited to, a concert, episodic television, a multiplayer video game, etc. can interact with a larger community at the regional, national or global level. The controller discovers distant, routed Remote Device Actors when the remote device attempts to contact the controller at a well-known address or when the remote contacts the controller using a lookup service. The controller can also use multi-cast or registered lookup services to discover the remote devices.

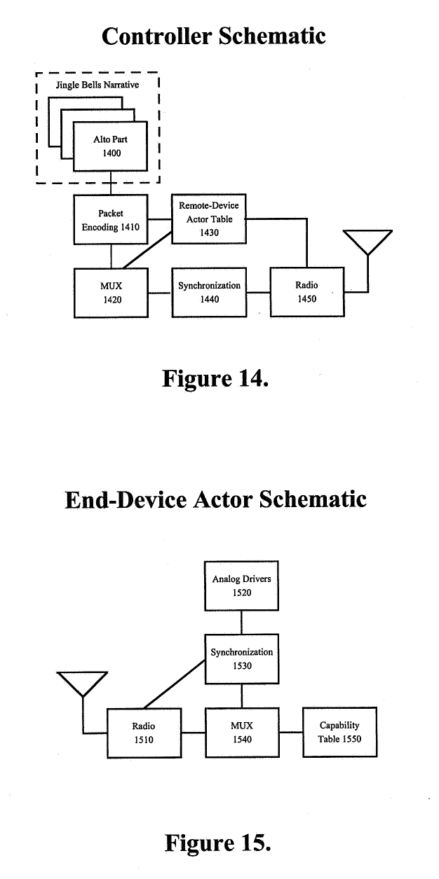

FIG. 14 contains a schematic of the network Controller function. A Narrative with Parts 1400 is providing a stream of commands from each sequence in the narrative. The controller maintains a mapping of actors to parts 1430 that it uses to encode and address commands in packets 1410 to individual or groups of End Device Actors. The multiplexer 1420 runs the process that maps commands to Endpoints on Remote Device Actors. The now ready commands get scheduled for transmission using flow control and synchronization techniques mentioned later. When the scheduler discovers that it is time to broadcast a command it sends the command packet to the radio 1450 for transmission.

FIG. 15 contains a schematic of the Remote End Device function. The radio 1510 receives the command packet and the multiplexer 1540 maps the packet to the proper analog driver 1520. The remote device also contains a scheduler 1530 that computes the proper time to send the command to the analog driver 1520 for execution. The analog driver 1520 converts the command into an analog signal used to drive a physical device such as a speaker, motor, light, switch, etc. The Remote Device Actor also maintains a capabilities table 1550 that it sends to the controller when it joins the network. The controller uses this table to help map Parts and Sequences to the End Device Actor's Endpoints.

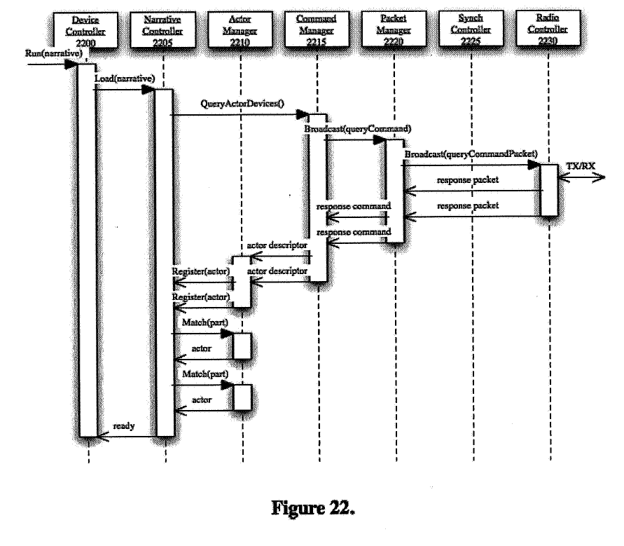

FIG. 22 contains a UML sequence diagram that further documents the process of locating and matching End-Device Actors to Parts. The blocks across the top of FIG. 22 represent class components used to model key components of a software system within the controller capable of implementing functionality of the invention.

Device Controller 2200 receives a Run(narrative) message to start running a new narrative. The Narrative Controller loads the narrative from storage or network, and then sends the QueryDeviceActors( ) message to the Command Manager 2215. The Command Manager 2215 encapsulates the request into a query command and sends the Broadcast(queryCommand) message to the Packet Manager 2220. The Packet Manager 2220 encapsulates the query command into a packet and sends the Broadcast(queryCommandPacket) to the Radio Controller 2230. The Radio Controller 2230 sends the command into the wireless network. The Radio Controller 2230 receives all of the response packets from the End-Device Actors and forwards them to the Packet Manager 2220. The Packet Manager 2220 extracts the response command from the packet and sends the command to the Command Manager 2215. The Command Manager extracts the response from the response command and sends it to the Actor Manager 2210. The Actor Manager 2210 maintains all relevant information about End-Device Actors known to the Controller. The Actor Manager 2210 registers any new End-Device Actors it finds by sending the Register(actor) message to the Narrative Controller 2215.

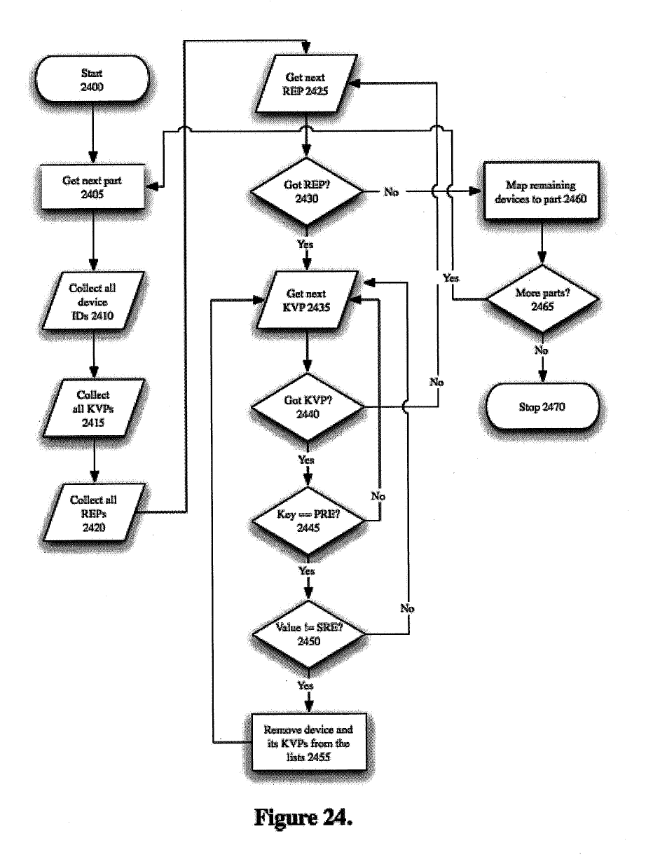

The Narrative Controller 2215 will then attempt to match the End-Device Actor with a Part in the current Narrative using, for example, the logic found in the flowchart of FIG. 24.

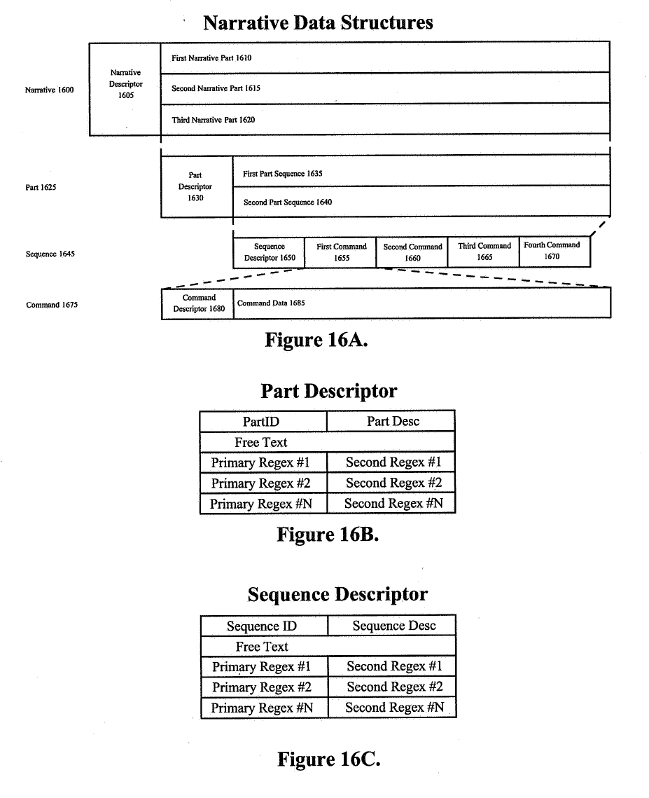

Refer now to the block diagram of FIG. 16A which for example, contains high-level model of data structures within a Narrative including logic of mapping: Part Descriptor 1630 and the Sequence Descriptor 1650. FIGS. 16B and 16C contain the detail of the Part Descriptor and Sequence Descriptor.

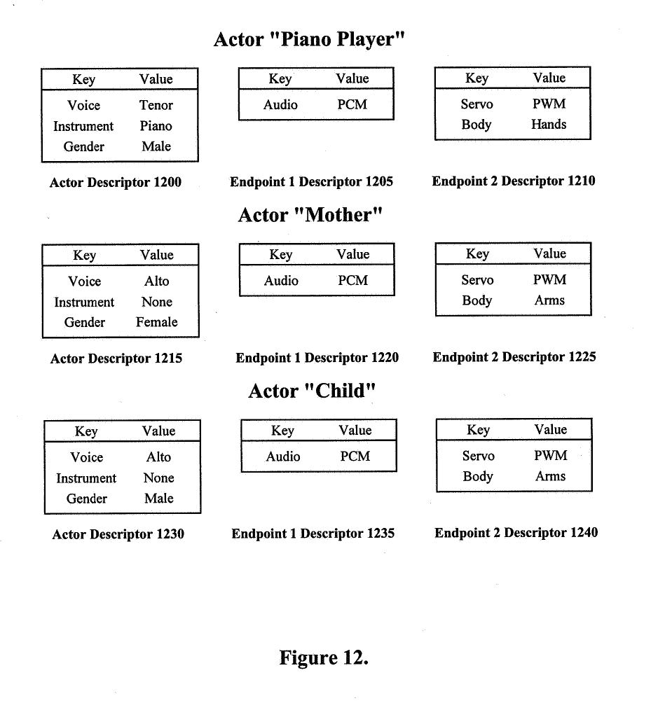

Both structures of 16B and 16C contain a list of Regular Expression Pairs (REPs): a pair of text values named PrimaryRegex and SecondaryRegex and numbered 1 through N. The End-Device Actors have a corresponding structure called a Key Value Pair (KVP) that are also a pair of text values named Key and Value and numbered 1 through N. FIG. 12 contains an example of these corresponding structures within the End-Device Actor. Actor Descriptor Tables 1200, 1215, 1230 correspond to the Part Descriptor Table, and End-Point Descriptor Tables 1205, 1210, 1220, 1225, 1235, 1240 correspond to the Sequence Descriptor Table.

Referring again to FIG. 24, at step 2400 the Controller has finished polling all of the End Devices in the network. At step 2405 the Controller extracts the next Part from the Narrative and prepares to match it to one or more of the End-Device Actors. At step 2410 the Controller builds a list of all End-Device Actors found in the network. At step 2415 the Controller builds a list of all KVPs returned by the found End-Device Actors. In step 2420 the Controller builds a list of all REPs found in the Part Descriptor. The outer-most loop of the matching process starts by getting the first REP from the list of REPs. Step 2425 checks that there are remaining REPs, and if there is continues to step 2435 where the controller gets the next KVP from the list.

Step 2440 checks that there are remaining KVPs in the list, and if so continues to step 2445 where the current Key of the KVP is matched against the Primary Regular Expression (PRE) of the REP. If the Key matches the PRE then this indicates that the Part wants to include this KVP in the Part matching test, and the process jumps to step 2450 where it checks if the Value of the KVP matches the Secondary Regular Expression (SRE) of the REP. If the two values do not match then the end device is removed from the list and thus eliminated as a match for the Part.

The process jumps to step 2435 to check the next KVP in the list. The outer loop of step 2425 continues until there are no more REPs remaining in the list, and then jumps to step 2460 where all of the End-Device Actors remaining in the list are matched to the Part. The process then checks if there are more Parts in the Narrative to match. If not, the process stops in step 2470. If there are Parts remaining in the Narrative then the process jumps to step 2405. This matching scheme allows the designer of the Narrative arbitrary complexity for matching Parts to End-Device Actors ex post facto. That is, the Narrative design can accommodate End-Device Actors that did not exist at the time of the Narrative's creation. Moreover, the use of successive regular expressions with a keyed selection system affords the designer arbitrary complexity for designing a match system for any conceivable implementation of the invention. It is also important to note that algebra of the regular expression matching could simplify to something as simple as matching to two static string pair sets. e.g.: REP=name/jane matches KVP=name/jane.

In one embodiment of the application the key-matching algorithm may employ dynamic key information related to the current position or disposition of the end device actors. For example, some of the end device actors can compute their physical or logical position using, but not limited to, GPS, voice interface, Internet address, domain name, radio range, mesh network position, stored configuration, etc.

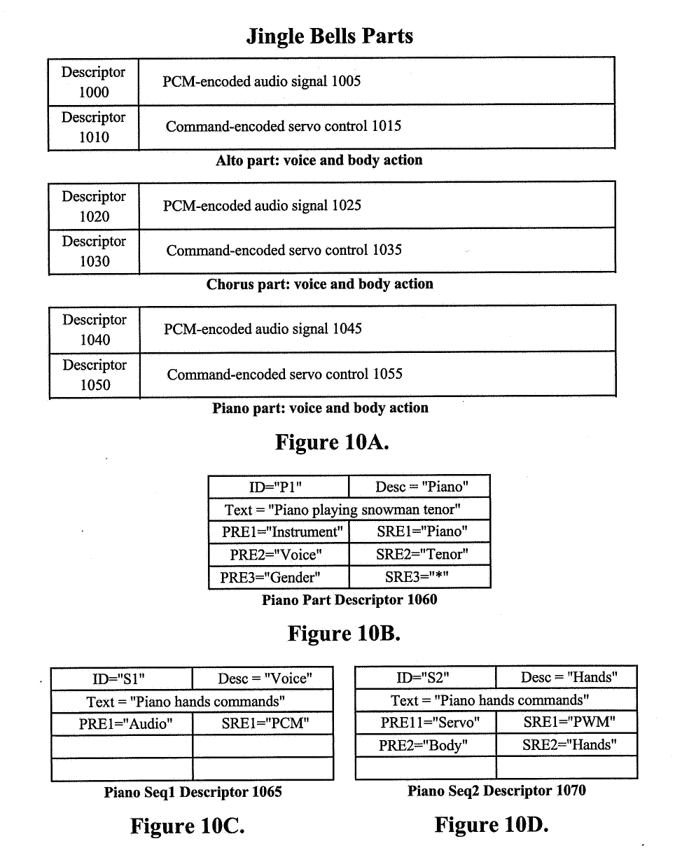

Applying the process of FIG. 24 to the sample data structures of FIG. 10A, FIG. 10B, and FIG. 12 we can see an example match. FIG. 10B is the Part Descriptor for the part that contains Sequences 1040 and 1050 of FIG. 10A. Assuming the controller finds only the End-Device Actor types specified in FIG. 12 the controller will match as follows. Starting with REP “Instrument/Piano” (KR1/VR1) the controller will attempt to find any End-Device Actor whose Key matches “Instrument”. All three End-Device Actors match, so the controller will attempt to find-any End-Device Actor whose Value matches “Piano”. Only the End-Device Actor “Piano Player” matches, so it stays in the list. Next the controller attempts to match the Key “Voice” to the remaining End-Device Actors. End-Device Actor “Piano Player” matches this key, so the controller will match the Value “Tenor” from the Part Descriptor to the Value “Tenor” in the End-Device Actor Descriptor. Since “Piano Player” matches it remains in the list. Next the controller attempts to match the Key “Gender” to the remaining End-Device Actors. End-Device Actor “Piano Player” matches this key, so the controller will match the Value “*” from the Part Descriptor to the Value “Male” in the End-Device Actor Descriptor. Since “Piano Player” matches it remains in the list. Since there are no more REPs to check the matching stops, and the remaining End-Device Actors in the list get mapped to the Part, in this case “Piano Player” gets mapped to the “Piano part”.

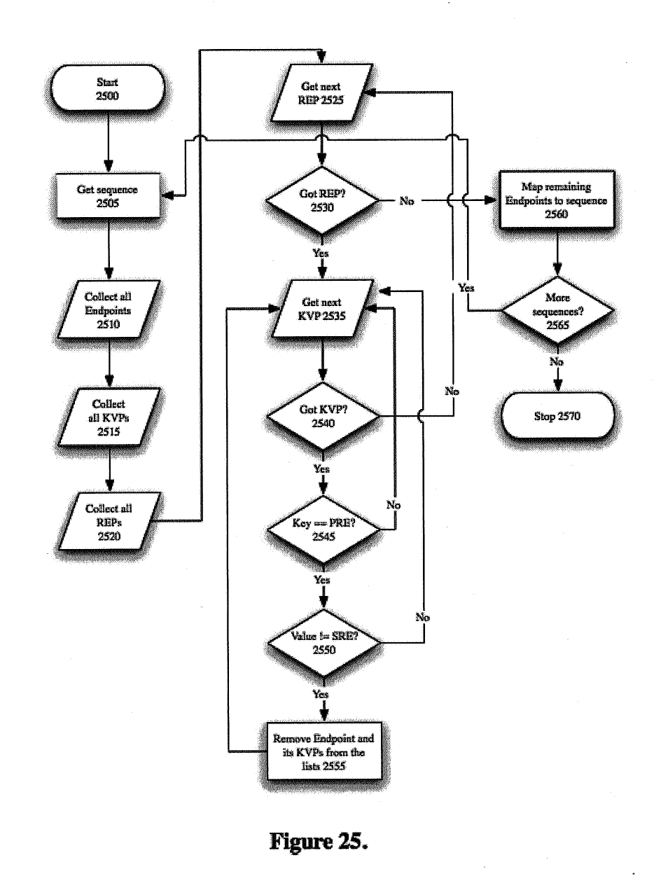

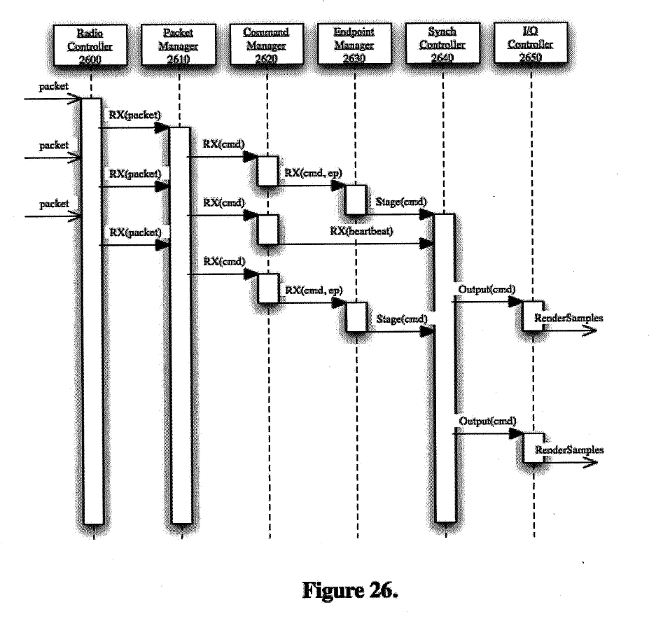

After mapping a Part to End-Device Actors, the Narrative Controller 2215 attempts to match Endpoints to the Sequences in the current Part using the logic found in the flowchart of FIG. 25. FIG. 16A contains high-level model of data structures within a Narrative including logic of mapping: Sequence Descriptor 1650. FIG. 16C contains the detail of the Sequence Descriptor. The structure of FIG. 16C contains a list of Regular Expression Pairs (REPs): a pair of text values named PrimaryRegex (PRE) and SecondaryRegex (SRE) and numbered 1 through N. The Sequences have a corresponding structure called a Key Value Pair (KVP) that are also a pair of text values named Key and Value and numbered 1 through N.

FIG. 12 contains an example of the KVP structures within the End-Device Actor. Example End-Point Descriptor Tables 1205, 1210, 1220, 1225, 1235, 1240 correspond to the Sequence Descriptor Table.

Referring again to FIG. 25, at step 2500 the Controller has finished mapping End Devices to the Part. At step 2505 the Controller extracts the next Sequence from the Part and prepares to match it to one or more of the Endpoints. At step 2510 the Controller builds a list of all Sequences found in the part. At step 2515 the Controller builds a list of all KVPs returned by the found Endpoints. In step 2520 the Controller builds a list of all REPs found in the Sequence Descriptor. The outer-most loop of the matching process starts by getting the first REP from the list of REPs. Step 2525 checks that there are remaining REPs, and, if there is, the process continues to step 2535 where the controller gets the next KVP from the list. Step 2540 checks that there are remaining KVPs in the list, and, if so, continues to step 2545 where the current Key of the KVP is matched against the Primary Regular Expression (PRE) of the REP.

If the Key matches the PRE then this indicates that the Sequence wants to include this KVP in the Sequence matching test, and the process jumps to step 2550 where it checks if the Value of the KVP matches the Secondary Regular Expression (SRE) of the REP. If the two values do not match then the EndPoint is removed from the list and thus eliminated as a match for the Sequence.

The process jumps to step 2535 to check the next KVP in the list. The outer loop of step 2525 continues until there are no more REPs remaining in the list, and then jumps to step 2560 where all of the Endpoints remaining in the list are matched to the Sequence. The process then checks if there are more Sequences in the Part to match. If not, the process stops in step 2570. If there are Sequences remaining in the Part then the process jumps to step 2505.

This matching scheme allows the designer of the narrative arbitrary complexity for matching Sequences to Endpoints ex post facto. That is, the Narrative design can accommodate Endpoints that did not exist at the time of the Narrative's creation. Moreover, the use of successive regular expressions with a keyed selection system affords the designer arbitrary complexity for designing a match system for any conceivable implementation of the invention. Note that algebra of the regular expression matching could simplify to something as simple as matching to two static string pair sets. e.g.: REP=name/jane matches KVP name/jane.

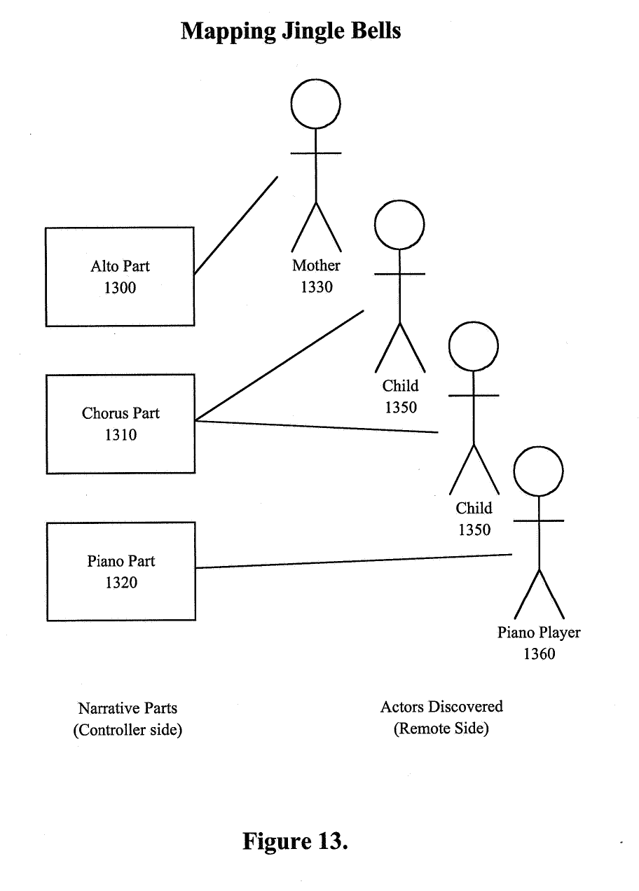

Applying the process of FIG. 25 to the sample data structures of FIG. 10A, FIG. 10C, and FIG. 12 we can see an example match result in FIG. 13. FIG. 10C is the Sequence Descriptor for the Sequence 1040 of FIG. 10A. Assuming the controller finds only the Endpoint types specified in FIG. 12, the controller will match as follows: Starting with REP “Audio/PCM” (KR1/VR1) the controller will attempt to find any Endpoint whose Key matches “Audio”. Only Sequence 1205 matches, so then controller will attempt to match the Value “PCM”. Sequence 1205 matches, so it stays in the list. Since there are no more REPs to check the matching stops, and the remaining Endpoints in the list get mapped to the Sequence, in this case Sequence 1065 gets mapped to Endpoint 1205. This mapping is made clear in FIG. 13 where Piano Part 1320 matches an Endpoint on the actor 1360. The process above would continue until we had the result mapping shown in FIG. 13.

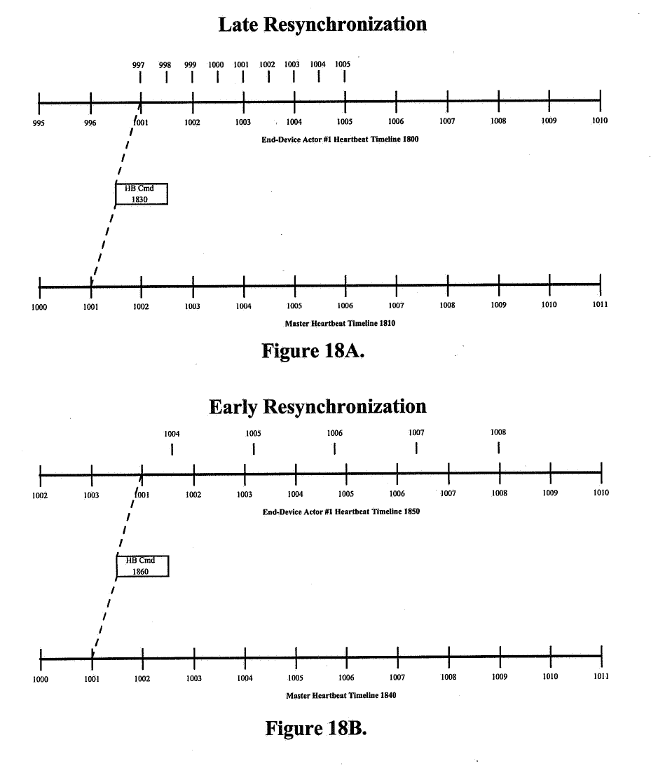

After matching the End-Device Actor Endpoints to Part Command Sequences the Controller broadcasts the first of many periodic synchronization commands. Referring to FIG. 18A the Controller's Master Heartbeat Timeline 1810 increments at a constant, known rate. Again Referring to FIG. 18A, each End-Device Actor maintains it own Remote Heartbeat Timeline 1800 whose count and rate mirrors that of the Controller's Master Heartbeat Timeline 1810 (subject to a small propagation delay that is nearly equal in all End-Device Actors). When the End-Device Actor receives a Synchronization Broadcast there are three possible outcomes:
1. The two timelines are close enough that the End-Device Actor need not take any action.
2. The Remote Heartbeat Timeline is behind the Master Heartbeat Timeline, and needs to catch up.
3. The Remote Heartbeat Timeline is ahead of the Master Heartbeat Timeline and needs to slow down.

For case 2 above refer to FIG. 18A. The Controller broadcasts the Synchronization Command 1830 with the value 1001, and the End-Device Actor receives it. When the End-Device Actor compares the two timelines it finds that it's next value 997 is behind, and decides on one of two actions for re-synchronizing: skip to the correct value, or accelerate its own Heartbeat fast enough and long enough to catch up, and then return to the standard rate. For case 3 above refer to FIG. 18B. The Controller broadcasts the Synchronization Command 1860 with the value 1001, and the End-Device Actor receives it. When the End-Device Actor compares the two timelines it finds that its next value 1004 is ahead, and decides on one of two actions for re-synchronizing: skip to the back to the correct value, or decelerate its own Heartbeat slow enough and long enough to catch up, and then return to the standard rate.

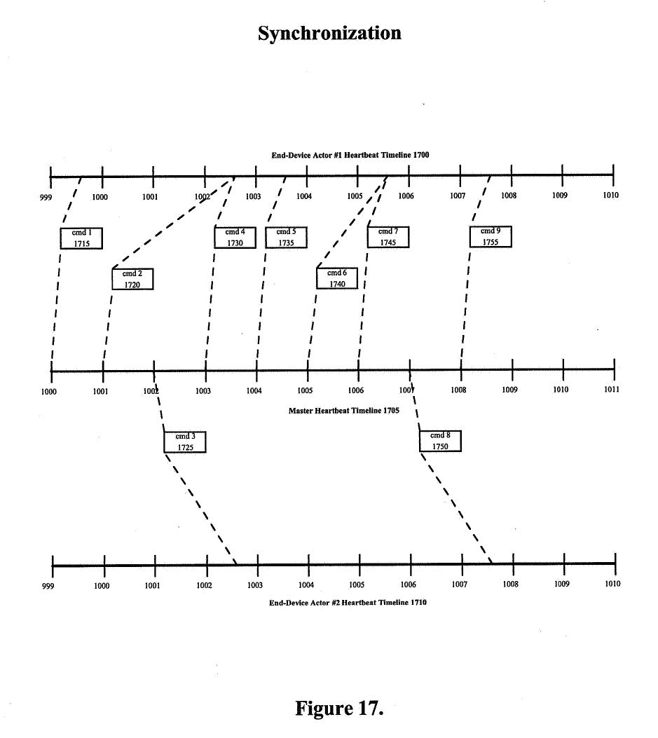

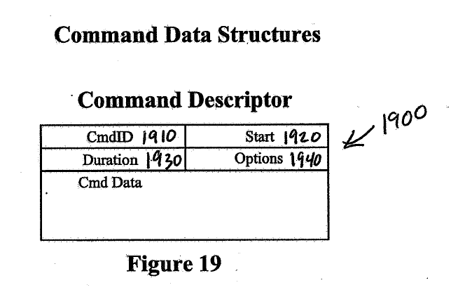

FIG. 17 depicts the Controller sending Commands to two End-Device Actors 1700 and 1710. The Command data structure of FIG. 19 shows that individual commands 1900 with ID 1910 indicate when they start and how long they will run. The start time (start 1920) is absolute or relative. The run time (duration 1930) is absolute. The options 1940 may include requests to repeat the command, or some other modification of the command intention. The Master Heartbeat Timeline 1705 indicates the time when the Controller transmitted a command. The End-Device Actor Heartbeat Timelines indicate when the command executed. The position of the boxes in the middle represents the time when the End-Device Actor Received the Command. In the case of commands 1720 and 1730 each was sent at a different time, but they both execute at the same time. This is because the Controller decided that it was more important to send Command 1725 right after Command 1720.

For stream-oriented data such as PCM-encoded audio the relative start time of the next command is immediately after the current command. However, in case of compression the duration of a command is variable length even when the byte length of each command is the same, because the number of samples in the compressed data depends on how well the compressor is able to compress that set of samples. For this reason calculating when a certain Command should start in absolute time is difficult. However, the Controller preferably uses knowledge embedded in the command prior to compression about when a command needs to execute in absolute time, so that it can efficiently schedule its transmission over the wireless network. To solve this problem the compression system keeps track of which samples it put into each command, and stores the starting heartbeat number of the first sample and the sample count in the command header. The controller may or may not transmit the start time and sample count as part of the command, but in all events it uses that heartbeat number to determine when to transmit the command. This allows the Controller to maximize the use of the bandwidth, and, do so without overloading the buffers in the End-Device Actors.

FIG. 34 contains a UML sequence diagram for processing commands in the End-Device Actor. A packet arrives at the Radio Controller 3400. The Radio Controller 3400 sends the Rx(packet) message to the Packet Manager 3410, and the Packet Manager unwraps the Command inside the packet, and sends the Rx(command) message to the Command Manager 3420. The Command Manager 3420 figures out the Endpoint for the command and sends the Rx(command, endpoint) message to the Endpoint Manager 3430. The Endpoint Manager stages the command for execution at the proper time by sending the Stage(cmd) message to the Synchronization Controller 3440. The Synchronization Controller 3440 compares the start time for the command to the current remote heartbeat number, and when the two match it sends the Output(command) message to the I/O Controller 3450. The I/O Controller 3450 then parcels out the data samples contained in the command at the correct sample rate. The second command that arrives at the End-Device Actor is the Heartbeat Synchronization Broadcast. Through the same Packet-Command chain described above, a synchronization command arrives at the Synchronization Controller 3440. The Synchronization Controller compares the remote heartbeat counter to the counter in the command, and if necessary adjusts the local heartbeat according to the logic mention previously with respect to FIGS. 18A and 18B.

This, in one embodiment, the invention may be broadly described as a wireless system for coordinated narrative characterization and action.

The system wirelessly choreographs multiple narrative characterizations amongst one or more appropriate end devices that can render those characterizations in a meaningful and entertaining way. A narrative characterization is a choreographed sequence of actions broken down into multiple “parts” for one or more “actors”. A “part” is a sequence of dialogue, sound, movement, action, gesture, etc. An “actor” is a narrative fictional or non-fictional character or personality.

Using a self-assembling wireless protocol, a server, acting as a coordinator, takes inventory of all end-device actors within its radio range and control. Each device tells the server what characteristics that device supports including, but not limited to, physical characteristics such as sound generation, light generation, animatronics, and narrative characteristics such as character name, gender, age, magical powers, team, etc.

The server is then able to process, from a file, network, core memory, or other digital source, one or more multiplexed, multipart data/command streams or one or more unipart data/command streams, and map those data/commands to an appropriate end device actor that can pleasantly render the parts. Each character receives its “part” from the airwaves, and maps the commands to the appropriate I/O ports to render the action using light, sound, animatronics, or any other means of performance. Moreover it synchronizes these actions to a central heartbeat encoded by the server to assure that each actor renders its actions in concert with all of the other characters controlled by the server.

Sample Application #1

A manufacturer provides a series of holiday figures that have prescribed personalities. For example: a dad, mom and child snowman carolers' chorus. The manufacturer also supplies data/command sets that cause these actors to “perform” together, perhaps with each actor singing and dancing in their own, unique voice and style. The command/data stream can contain more parts than there are suitable “end device actors” within radio range. This allows for future inclusion of new character actors. Perhaps these characters don't exist yet, or the end user doesn't own them. Later inclusion of these extra character actors within radio range causes these new characters to automatically participate in the rendering of the narrative: e.g. the addition of sister, grandfather, deer, mice, etc. to the company of snowmen carolers. This system may, for example, be implemented in a yard of a home in a residential neighborhood. Additional or new characters may be added by other members of the neighborhood who purchase additional holiday (or similarly themed) figures (characters/actors). In one embodiment, the range of the network is extended by networking additional characters/actors through existing characters/actors. The invention may be extended to the point that holiday figures across an entire town are synchronized to the same performance which would then, for example, be best viewed from a hillside or airplane in order to get the full effect which may include, for example, ping-pong style or other synchronizations between individual residences or whole neighborhoods in the town.

Given that each character can perform their part independently, it is possible to incorporate a deeper, more pleasing narrative experience than you would get with a single, rendered, wireless music stream played through one or more speakers in unison.

Sample Application #2

A toy manufacturer provides a series of super/hero action figures that become involved in one or more narrative situations such as crime fighting, police rescue, firefighting, battling space aliens, etc. As a user plays with the character actors each actor would follow a series of actions synchronized to the overall narrative as well as the actions of the other actors. For instance: a fire alarm action that initiates a sequence of events and coordinated dialogue among firemen actors in a fire station. The timing of future actions may depend on the completion of a sequence of in-progress actions: the fire chief tells fireman A: “Fireman A rescue a woman on the fourth floor!” Fireman A character says “Yes, sir, chief!” Upon completion of the rescue the woman actor says “Thank you!”

Sample Application #3

A non-fictional pop music group creates action figures of themselves where each character actor plays their real part in the rendering of the group's own music: the drummer plays drums;, the lead singer sings lead, the guitarist plays guitar, etc.

The following devices may be used to implement any one or more of the features described above

The Data Stream

The data stream contains either one or more integrated, multiplexed, multipart character data/command streams and/or one or more uni-part data/command streams. Each character in the narrative maps to a character in one or more streams. Some parts may be multicast, in that they are appropriate for more than one character such as a chorus. Each part stream contains a descriptor, narrative characteristics, optional rights management and a stream of data/commands. The characteristics mapping is an n-dimensional array that provides clues that help the server coordinator map the part to a suitable end device character.

The Server

The server has five major components: a source stream decoder, a multiplexer, a device map, a gateway, and a radio.

Decoder

The decoder accepts one or more data/command streams that contain data/commands for rendering the coordinated narrative. The decoder extracts the data chunks from the input stream (file, network, flash memory etc.) and reassembles them into individual uni-part data/command streams suitable for a single character actor capability in the narrative. E.g. A singing voice.

Device Map

The server creates and maintains a map of character actor end-devices within its radio range and control. The remote devices transmit a set of device characteristics that help the server coordinate the distribution of character data/commands in a logical and timely fashion.

Multiplexer

The multiplexer uses the device map and output from the decoder to parcel the character streams into suitable, over-the-air packets destined for the correct end device.

Gateway

The gateway accepts the data/command packets and loads them onto the media access control layer of the network. It deals with coordination, retry, and other network management issues.

MAC/Radio

The radio transmits the packets in a manner suitable to the modulation employed, including unicasting, multicasting and any other necessary network handling needed to assure delivery of the packets to the end receivers.

End Device

The end device contains six parts: a radio, a data/command decoder, a characteristics map, a multiplexer, a synchronizer, and I/O ports.

MAC/Radio

The radio receives the packets in a manner suitable to the modulation employed, including the reception of unicast and multicast packets.

Decoder

The decoder receives the raw data/command packets from the radio and converts them in to binary instructions/data suitable to drive I/O appropriate for rendering the narrative characterizations. E.g. Generation of sound, control of animatronics, switching of lights, and/or controlling an external load.

Characteristics Map

The characteristics map is an n-dimensional array that contains a mapping of individual characteristics to a specific I/O port. E.g. sound/data commands get directed to a suitable I/O port connected to a speaker or other pulse-width modulation device capable of generating a sound from an encoded waveform.

Multiplexer

The multiplexer maps the decoded commands to the appropriate I/O ports, and sends them to the synchronizer.

Synchronizer

The synchronizer coordinates itself with a system heartbeat maintained and transmitted by the server controller. Each data/command packet contains a time-to-play encoding that allows the end device to make a “best effort” to render the narrative characterization at the appropriate time. By “best effort” we mean that data/commands that arrive late may not get played, or get played from the middle to “catch up,” or get cached until the correct time arrives to play them.

I/O

Each I/O port drives a device capable of producing the physical effects necessary to render the experience. Examples are driving a speaker, controlling lights, actuating motors, actuating switches, etc.

Data/Command Stream

The data/command stream is a multiplexed set of commands containing a series of data/commands for one or more parts for one or more character actors.

Unipart Stream

This stream contains a series of data/commands for a single part. This part may be appropriate for one or more character actors. The stream contains a header descriptor used for identification, versioning, provisioning or any other kind of data management task necessary to store, deliver, route, execute, record the series of actions for the part. The stream then contains a characteristics block used to help map the part to the right kinds of end device character actors. This would include physical information such as capability type: sound, lights, animatronics, etc, or narrative information such as character name, age, team, etc. The next section is an optional digital rights management section used to verify rights of the end user to employ the data/command stream. The remainder of the stream contains one or more data/commands.

Multiart Stream

This stream contains a series of multiplexed unipart data/command streams.

Data Packet

The data packet can contain all or part of a binary coded representation of a physical entity. An example is a data packet that encodes all or part of a sound sample, a video segment, etc.

Command Packet

The command packet contains a structured instruction suitable for interpretation by an end device. An example is a command packet that contains instructions for a character actor to perform particular dance step.

Multiplexing

The data/commands contained in a data stream do not need to nominate a specific end device, or even a specific character actor capability. Instead these data/commands can nominate a generic capability that the server controller can resolve to an end-device character actor capability. For example, the server may receive a data/command stream that contains, among other things, a voice part for a male child. The server may detect that there is a suitable character in radio range that has an I/O port connected to a speaker that can render the voice of a male child.

Address

This is the address by which the server can contact the end-device character actor.

Profile

A profile indicates the class of the end-device character actor. Members of a musical group would each have the same profile ID that is unique to their group and no other set of characters from any other narrative context.

Endpoint

The endpoint refers to the operating system task within the end-device and the server controller that handle a certain class of data/commands.

Capability

Within an endpoint there are one or more character capabilities. When the end-device character actor endpoint task receives a data/command packet it routes the data/command to the correct capability specified in the packet. In the implementation of the end-device a capability may result in a mapping of data/commands to one or more encoding schemes and/or I/O ports.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, creating a wireless network, associating devices with appropriate characteristics, creating, transmitting, receiving and parsing packets, scheduling packet transmission to maximize bandwidth, extracting commands from packets, synchronizing commands in time among many devices in a wireless network, staging I/O, generating I/O signals, and the display, storage, or communication of results according to the processes of the present invention.

Obviously, numerous modifications and variations of the present invention are possible in light of the above teachings. It is therefore to be understood that within the scope of the appended claims, the invention may be practiced otherwise than as specifically described herein.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a controller, any other device appropriately configured is an equivalent device, such as a programmable device, server, or other device having an equivalent capability, whether or not listed herein, may be substituted therewith. Furthermore, the inventors recognize that newly developed technologies not now known may also be substituted for the described parts and still not depart from the scope of the present invention. All other described items, including, but not limited to radios, media content, network configurations, communication schemes, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, establishing and maintaining a heartbeat, synchronizing multiple devices to a heartbeat, synchronizing a performance among multiple devices, issuing commands, preparing a multi-part data stream, self-configuring wireless actors, accepting commands, implementing commands implementing commands according to a synchronized heartbeat, and the storage, communication, or performance of commands or parts according to the processes of the present invention.

The present invention may suitably comprise, consist of, or consist essentially of, any of element of the various parts or features of the invention and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A system for implementing a synchronized narrative performance, comprising:
a coordinator configured to create a wireless network of end-devices actors capable of performing synchronized commands;
an end-device actor configured to accept commands from the coordinator, and able to execute those commands relative to a central heartbeat maintained by the coordinator;
said central heartbeat maintained by the coordinator and propagated to the end-device actors.
a narrative data structure configured to contain thematically linked, synchronized parts meant for performance in concert, and organized for one or more end-device actors;
a narrative sub-structure called part and configured to contain synchronized sequences meant for performance in concert, and organized for one or more end-points within one or more end-device actors;
a narrative sub-structure called sequence, and configured to contain synchronized commands meant for performance in concert, and organized for synchronous execution within an I/O device connected to targeted end-point;
a synchronized command meant to execute at a specified time for a specified duration in coordination with other commands executing in the same or other end-device actors;
a set of identifiers for each part within the narrative;
a set of capabilities for each part within the narrative;
a set of identifiers for each sequence within each part of the narrative;
a set of capabilities for each sequence within each part of the narrative;
an actor descriptor table containing the identities and capabilities of each end-device actor within the network;

2. The system according to claim 1, where said processing mechanism is an embedded CPU within the synchronized narrative performing device.

3. The system according to claim 1, wherein said processing mechanism is an embedded CPU within a network node.

4. The system according to claim 1, wherein said network nodes form a peer-to-peer network, a star network, or a mesh network.

5. The system according to claim 1, wherein said network nodes uses at least one of peer-to-peer, broadcast, and coordinated network traffic patterns.

6. The system according to claim 1, further comprising:
a master heartbeat coordinator;
wherein said heartbeat coordinator comprises,
a master heartbeat within the coordinator,
a counting mechanism within the heartbeat with sufficient resolution to coordinate the synchronous execution of commands from the narrative, and a counting mechanism within the heartbeat with a predictable increment rate known to all devices in the network.

7. The system according to claim 1, further comprising:
a remote heartbeat coordinator;
wherein said remote heartbeat coordinator comprises,
a remote heartbeat within each end-device actors synchronized to the master heartbeat within the coordinator, and
an adjuster configured to alter an increment rate of the end-device actor remote heartbeat to slow or speed the increment rate.

8. The system according to claim 1, further comprising:
a command transmission scheduling system;
wherein said scheduling system comprises,
a vector of buffer sizes for each mapped endpoint in a narrative-endpoint mapping table, and
a vector of byte counts for all outstanding, unexecuted commands delivered to each end-point wherein outstanding commands are those sent, but not scheduled to execute according to the master heartbeat and start time registered or computed for the command.

9. The system according to claim 1, further comprising:
an end-device actor command execution scheduler;
wherein said scheduler comprises,
an end-device actor heartbeat counter, and
a vector of next commands pending at each endpoint; and
said scheduler is configured to,
iterate over each endpoint in the vector,
compare the start time of the command to the current end-device heartbeat counter number, and
if the start time falls within an acceptable time window then start execution of the command.

10. The system according to claim 1, wherein the system further comprises an allocation device configured to allocate at least one portion of the performance to an actor having attributes that match an attribute of the allocated performance portion.

11. The system according to claim 1, further comprising:
an endpoint command execution system;
wherein:
said endpoint command execution system comprises,
an end-device actor heartbeat counter, and
one or more I/O ports connected to the endpoint;
said endpoint command execution system is configured to,
execute commands that contain one or more data samples at a known sample rate, and
schedule a next sample by,
comparing the sum of a heartbeat count value of a last sample and a duration of one sample to a current heartbeat counter number, and
if the sum and duration values fall within an acceptable time window then send the next sample to the I/O.

12. A method of matching parts from a narrative to one or more end-device actors found in the network, comprising the steps of:
iterating over each part from the narrative,
comparing the identity of each end-device actor in said actor descriptor table to characteristics of the part,
retaining for the part only those actors with suitable characteristics,
comparing the capability of each end-device actor in said actor descriptor table to capabilities of the part,
retaining for the part only those actors with suitable capabilities,
iterating over each sequence from the part,
comparing the capability of each end-device actor endpoint in said actor descriptor table to capabilities of the sequence,
retaining for the sequence only those endpoints with suitable capabilities, and
associating all matches within the narrative-endpoint mapping table as determined above.

13. A method of re-synchronizing a remote master heartbeat of a coordinator with a remote heartbeat of end-device actors, comprising the steps of:
periodically broadcasting a current master heartbeat counter number to the end-device actors;
comparing the broadcast current heartbeat number to the internal heartbeat number within the end-device actors;
if the heartbeat numbers do not match performing, by each of the end-device actors, one of three actions comprising:
slowing the end-device actor heartbeat for a set period of time until the two counters match;
speeding the end-device actor heartbeat for a set period of time until the two counters match; and
jumping the end-device actor heartbeat to the same number as the master heartbeat.

14. A method of determining a next command to transmit, comprising the steps of:
iterating over a set of endpoints, the steps of,
computing a size of a next command for an endpoint,
computing a remaining command data in a buffer of the endpoint,
computing a remaining buffer space in the endpoint's buffer; and
selecting the endpoint with the greatest need for its next command and sufficient space to buffer its next command.

15. The method according to claim 14, wherein the end-points comprise animated characters in a self-configuring network and the next command comprises a portion of a synchronized performance transmitted to the selected endpoint.

16. A system, comprising:
a series of actors configured to synchronously perform portions of a performance;
wherein:
each of the actors is a node in a self configuring wireless network;
each actor comprises at least one of an animated character, lighting device, and sound device; and
the performance is at least one of a audio performance, choreographic performance, and lighting performance.

17. The system according to claim 16, further comprising an allocator configured to allocate at least one portion of the performance to each actor.

18. The system according to claim 17, wherein the allocator is further configured to allocate at least one portion of the performance to at least one of the actors having attributes that match an attribute of the allocated performance portion.

19. The system according to claim 17, wherein the allocator is further configured to allocate at least one of the performance portions based on locations of the actors.

20. The system according to claim 16, further comprising a synchronizer configured to synchronize a master heartbeat with at least one local heart beat used by at least one of the actors.

21. The system according to claim 16, wherein the performance comprises a themed holiday performance, and the self configuring network nodes comprise actors or groups of actors located at different residences in a residential neighborhood.

22. A computer program product, comprising a readable media having instructions stored thereon, that, when loaded into a computer, cause the computer to perform the steps of:
initiating a wireless controller device;
searching and identifying, via the wireless controller device, a set of wireless enabled end-devices;
sending an individual part of a narrative to be performed to each end-device of the set of end-devices; and
synchronizing the performances of the individual parts via a master heart beat and a set of heartbeats in the end-devices.

23. The computer program product according to claim 22, wherein said steps further comprise:
synchronizing heartbeats in the end-devices with a master heartbeat.

24. The computer program product according to claim 22, wherein the steps further comprise:
determining characteristics of each end-device; and
selecting the individual part for each end-device based on each end-device's characteristics.

25. The computer program product according to claim 24, wherein the end-device characteristics include capabilities needed for certain of the individual parts.

26. The computer program product according to claim 24, wherein the step of determining characteristics comprises determining a location of each end device.

27. The computer program product according to claim 22, wherein the narrative is a themed holiday performance, and the end-devices are at least one of animated characters, sound devices, and lighting devices.
